(19) United States
(12) Patent Application Publication
(10) Pub. No.: US 2025/0069320 A1
(43) Pub. Date: Feb. 27, 2025

(54) INFORMATION-PROCESSING APPARATUS, CONTROL METHOD OF INFORMATION-PROCESSING APPARATUS, AND NON-TRANSITORY COMPUTER-READABLE MEDIUM

(71) Applicant: CANON KABUSHIKI KAISHA, Tokyo (JP)

(72) Inventor: Takabumi WATANABE, Kanagawa (JP)

(21) Appl. No.: 18/806,741

(22) Filed: Aug. 16, 2024

(30) Foreign Application Priority Data
Aug. 25, 2023 (JP) 2023-137085

(51) Int. Cl. G06T 15/20; G06F 3/01; G06T 19/00; H04N 13/122; H04N 13/344

(52) U.S. Cl. CPC G06T 15/20; G06F 3/013; G06T 19/006; H04N 13/122; H04N 13/344

(57) ABSTRACT

An information-processing apparatus according to the present invention includes one or more processors and/or circuitry configured to perform determination processing of determining a third viewpoint, and perform generation processing of generating, in a case where a second object is present in foreground of a first object when viewed from the third viewpoint, an image of a view from a first viewpoint corresponding to a left eye and an image of a view from a second viewpoint corresponding to a right eye by drawing an image of the first object in foreground of the second object.

### BACKGROUND OF THE INVENTION

### Field of the Invention

The present invention relates to an information-processing apparatus, a control method of the information-processing apparatus, and a non-transitory computer-readable medium and, more particularly, to virtual reality, augmented reality, and mixed reality.

### Description of the Related Art

Virtual reality (VR), mixed reality (MR), and augmented reality (AR) are referred to as XR (cross reality). As a method of experiencing XR, a method using a head-mounted display (HMD) is known.

With an HMD, binocular vision is realized by respectively presenting (displaying) two images with parallax to two (left and right) eyes. The realization of binocular vision requires that “fusion” involving recognizing an object in one image and an object in the other image as a same object and integrating the objects be performed in a user and also requires the two images to be consistent. When the two images are not consistent, fusion is not performed, a double image or binocular rivalry occurs, and a sense of discomfort arises.

In XR, a user may wish to visualize another object present in the background of a given object (including another object present inside the given object). For example, a user may wish to display an indicator which indicates a position of a diseased organ on a body of a patient. A user may also wish to display an internal structure on a surface of a machine structure. When an object B in the background is displayed in a state where an object A in the foreground is visible, since a geometric anteroposterior relationship of the objects A and B and an anteroposterior relationship of appearances of the objects A and B contradict with each other (are not consistent), fusion is not suitably performed and binocular vision is not suitably realized. For example, a user may experience a sense of discomfort in which a sensation that the object B is present in the background of the object A (a sensation based on the geometric anteroposterior relationship) is mixed with a sensation that the object B is present in the foreground of the object A (a sensation based on the anteroposterior relationship of appearances).

Japanese Patent Application Laid-open No. 2018-106262 discloses a technique of detecting an inconsistency in a positional relationship between a real object and a virtual object.

In the case of VR, when visualizing another object that is present in the background of a given object, a user can realize suitable binocular vision without any sense of discomfort by translucently displaying the object in the foreground. In the case of AR or MR, the object in the foreground may be a real object. In such a case, translucently displaying the real object requires estimating an image in the background of the real object using a technique called diminished reality and a suitable display (a display which enables binocular vision to be suitably realized) cannot be readily performed. Another object which is present inside a given object can also be visualized by image processing which involves opening a hole in a surface of the given object. However, when comparing the object in the foreground with the inside object (the object in the background), image processing which involves significantly changing the appearance of the objects is not preferable.

### SUMMARY OF THE INVENTION

The present invention provides a technique which enables suitable display (display which enables binocular vision to be suitably realized) to be readily performed even when visualizing another object which is present in the background of a given object.

The present invention in its first aspect provides an information-processing apparatus including one or more processors and/or circuitry configured to perform determination processing of determining a third viewpoint, and perform generation processing of generating, in a case where a second object is present in foreground of a first object when viewed from the third viewpoint, an image of a view from a first viewpoint corresponding to a left eye and an image of a view from a second viewpoint corresponding to a right eye by drawing an image of the first object in foreground of the second object.

The present invention in its second aspect provides a control method of an information-processing apparatus, comprising determining a third viewpoint, and generating, in a case where a second object is present in foreground of a first object when viewed from the third viewpoint, an image of a view from a first viewpoint corresponding to a left eye and an image of a view from a second viewpoint corresponding to a right eye by drawing an image of the first object in foreground of the second object.

The present invention in its third aspect provides a non-transitory computer readable medium that stores a program, wherein the program causes a computer to execute a control method of an information-processing apparatus, the control method including determining a third viewpoint, and generating, in a case where a second object is present in foreground of a first object when viewed from the third viewpoint, an image of a view from a first viewpoint corresponding to a left eye and an image of a view from a second viewpoint corresponding to a right eye by drawing an image of the first object in foreground of the second object.

Further features of the present invention will become apparent from the following description of exemplary embodiments with reference to the attached drawings.

### BRIEF DESCRIPTION OF THE DRAWINGS

FIG. 1 is a block diagram showing a configuration example of a system;

FIG. 2 is a block diagram showing an example of a hardware configuration of an information-processing apparatus;

FIG. 3 is a flow chart showing an operation example of the system;

FIG. 4 is a schematic view showing an example of a positional relationship between each viewpoint and each object;

FIG. 5 is a schematic view for describing a processing example of step S3030 in FIG. 3;

FIG. 6 is a schematic view for describing a processing example of step S3060 in FIG. 3;

FIG. 7 is a block diagram showing a modification of the configuration of the system;

FIG. 8 is a flow chart showing a modification of operations of the system; and

FIG. 9 is a schematic view showing a modification of the positional relationship between each viewpoint and each object.

### DESCRIPTION OF THE EMBODIMENTS

An embodiment of the present invention will be described below. While an example in which the present invention is applied to video see-through MR which displays a composite image created by superimposing a CG object (virtual object) on an image of a real space captured by an imaging device such as a digital camera will be described in the present embodiment, the present invention is not limited thereto. For example, the present invention may be applied to optical see-through AR which superimposes (displays) a virtual object on a real space that is not an image. The present invention may also be applied to VR which displays a composite image in which a virtual object has been superimposed on an image of a virtual space.

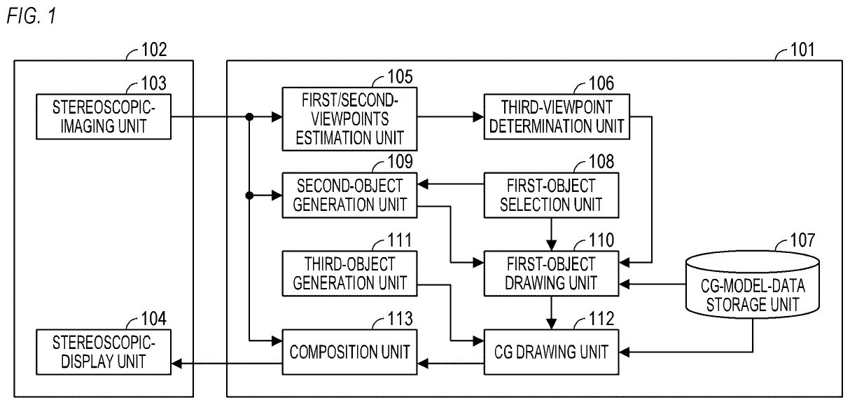

FIG. 1 is a block diagram showing a configuration example of a system according to the present embodiment. The system shown in FIG. 1 is constituted of an information-processing apparatus 101 and a head-mounted display (HMD) 102. The information-processing apparatus 101 may be a stationary computer such as a personal computer or a work station or a mobile terminal such as a smartphone or a wearable device. The information-processing apparatus 101 may be a part of the HMD 102.

The HMD 102 will be described. A stereoscopic imaging unit 103 captures two images with parallax as images of a real space. A stereoscopic display unit 104 respectively presents (displays) two composite images generated by the information-processing apparatus 101 (a composition unit 113) to the two (left and right) eyes of a user wearing the HMD 102 on the head. Methods of presenting (methods of displaying) the images are not particularly limited. For example, the images may be displayed on a display panel such as a liquid crystal panel or an organic EL panel provided at a position opposing the eyes of the user or the images may be directly projected onto the user's retinae using a laser.

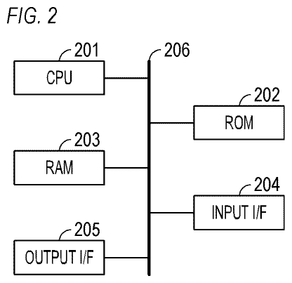

The information-processing apparatus 101 will be described. FIG. 2 is a block diagram showing an example of a hardware configuration of the information-processing apparatus 101. A CPU 201 is a control unit which controls the entire information-processing apparatus 101. Each functional unit of the information-processing apparatus 101 shown in FIG. 1 is realized by, for example, the CPU 201 (or a GPU, not illustrated). A ROM 202 is a nonvolatile memory which stores, in a non-transitory manner, a wide variety of data (information) including image data, audio data, other data, and various programs that enable the CPU 201 to operate. A RAM 203 is a volatile memory which temporarily stores a wide variety of data. The CPU 201 executes each function of the information-processing apparatus 101 by using the RAM 203 as a work memory in accordance with, for example, a program stored in the ROM 202. An input I/F 204 is an interface for inputting a wide variety of data (information) including image data, audio data, operation signals, and other data to the information-processing apparatus 101. An output I/F 205 is an interface for outputting a wide variety of data (information) including image data, audio data, control signals, and other data from the information-processing apparatus 101. These pieces of hardware are connected to a bus 206 and are capable of transmitting and receiving data via the bus 206. The information-processing apparatus 101 may be divided into a plurality of apparatuses. At least any of the plurality of functions of the information-processing apparatus 101 may be executed on the cloud or executed in the HMD 102.

A first/second-viewpoints estimation unit 105 shown in FIG. 1 estimates a first viewpoint (a position and an orientation of the first viewpoint) which corresponds to the left eye of the user and a second viewpoint (a position and an orientation of the second viewpoint) which corresponds to the right eye of the user. An estimating method is not particularly limited and the first viewpoint and the second viewpoint may be estimated by, for example, estimating a position and an orientation of the HMD 102. An inside-out technique such as Simultaneous Localization and Mapping (SLAM) may be used. In doing so, for example, the stereoscopic imaging unit 103 or a separate camera provided in the HMD 102 is used. An outside-in technique may be used. In doing so, motion-capture is used using, for example, a camera outside of the HMD 102.

A third-viewpoint determination unit 106 determines a third viewpoint (a position and an orientation of the third viewpoint). In the present embodiment, the third viewpoint is used to render a first object selected by a first-object selection unit 108 among objects (far-side objects) hidden by an object in the foreground (second object). In rendering of the first object, the first object is drawn in a view from the third viewpoint. The third-viewpoint determination unit 106 determines the third viewpoint based on, for example, at least one of the first viewpoint and the second viewpoint (the first viewpoint, the second viewpoint, or both viewpoints) estimated by the first/second-viewpoints estimation unit 105. Accordingly, since the third viewpoint which is close to both the first viewpoint and the second viewpoint is determined, the first object can be drawn in a view close to both a view from the first viewpoint and a view from the second viewpoint.

A CG-model-data storage unit 107 stores a wide variety of data including profile data, material data, and scene graph data of a CG (object) to be presented to the user.

The first-object selection unit 108 selects the first object from one or more objects. A selection method is not particularly limited. For example, the first-object selection unit 108 may select an object designated by the user as the first object. The user may designate (select) an object using a tree UI which represents a structure of a scene graph. The first-object selection unit 108 may automatically select an object satisfying predetermined conditions as the first object. The predetermined conditions may be conditions related to an attribute of the object set in advance or conditions related to tag information of the object set in advance.

A second-object generation unit 109 generates the second object (profile information of the second object). In the case of AR or MR, the second object may be a real object. In such a case, the second-object generation unit 109 generates, as the second object, a virtual object which reproduces a real object by three-dimensional reconstruction. A method of three-dimensional reconstruction is not particularly limited. For example, the second object may be generated using two images (stereoscopic images) obtained by the stereoscopic imaging unit 103 or the second object may be generated using a depth sensor. The second object may be generated from a plurality of images respectively corresponding to a plurality of viewpoints using Structure from Motion. In the case of VR, the second object need only be generated from a CG model.

A first-object drawing unit 110 draws an image of the first object on a rendering target in a view from the third viewpoint.

A third-object generation unit 111 generates the third object in the foreground of the second object in a view from the third viewpoint.

A CG drawing unit 112 attaches the image of the first object drawn by the first-object drawing unit 110 to a surface of the third object. The attachment may be interpreted as drawing the first object on the surface of the third object. In addition, as a CG (image) including the third object on which the image of the first object has been drawn, the CG drawing unit 112 generates a CG in a view from the first viewpoint and a CG in a view from the second viewpoint.

The composition unit 113 composites a CG generated by the CG drawing unit 112 on a real image (an image of a real space) captured by the stereoscopic imaging unit 103. The composition unit 113 generates a composite image corresponding to the first viewpoint by compositing a CG corresponding to the first viewpoint with a real image corresponding to the first viewpoint. In addition, the composition unit 113 generates a composite image corresponding to the second viewpoint by compositing a CG corresponding to the second viewpoint with a real image corresponding to the second viewpoint. The composite image corresponding to the first viewpoint is presented to the left eye of the user and the composite image corresponding to the second viewpoint is presented to the right eye of the user. Note that in the case of VR, the composition unit 113 is omitted and a CG (a composite image in which a virtual object is superimposed on an image of a virtual space) generated by the CG drawing unit 112 is presented to the user.

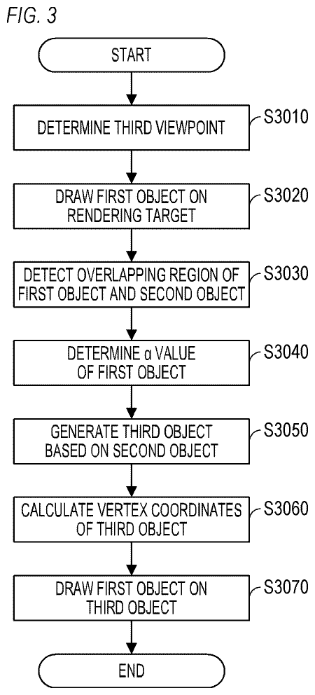

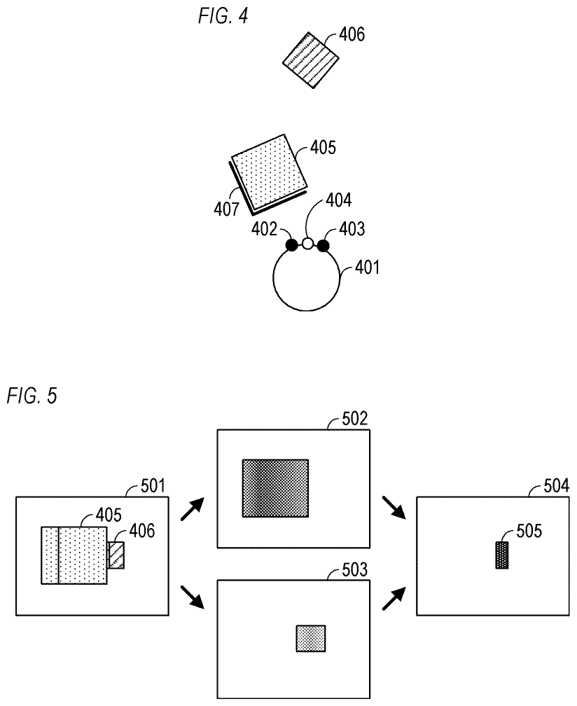

FIG. 3 is a flow chart showing an operation example of the system according to the present embodiment. FIG. 4 is a schematic plan view showing an example of a positional relationship between each viewpoint and each object.

In step S3010, the third-viewpoint determination unit 106 determines a third viewpoint 404 based on at least one of a first viewpoint 402 and a second viewpoint 403. For example, the third-viewpoint determination unit 106 determines a midpoint between the first viewpoint 402 and the second viewpoint 403 (a position of the midpoint and an average (intermediate) orientation of the first viewpoint 402 and the second viewpoint 403) as the third viewpoint 404 (a position and an orientation of the third viewpoint 404). The third-viewpoint determination unit 106 may determine the first viewpoint 402 or the second viewpoint 403 (one of the first viewpoint 402 and the second viewpoint 403) as the third viewpoint 404. In such a case, the third-viewpoint determination unit 106 may acquire information on a dominant eye of a user 401 and determine a viewpoint corresponding to the dominant eye between the first viewpoint 402 and the second viewpoint 403 as the third viewpoint 404. The information on the dominant eye is registered in the information-processing apparatus 101 by, for example, the user 401. The user 401 may spontaneously register the information on the dominant eye or may register the information on the dominant eye in response to a request from the information-processing apparatus 101. Note that a determination method of the third viewpoint 404 is not limited to the methods described above. For example, the third-viewpoint determination unit 106 may determine the third viewpoint 404 by adding a predetermined offset to the first viewpoint 402 or the second viewpoint 403.

In step S3020, the first-object drawing unit 110 draws an image of a first object 406 on a rendering target in a view from the third viewpoint 404. Let us assume that a projection matrix for drawing a CG in a view from the first viewpoint 402 is a first projection matrix and that a projection matrix for drawing a CG in a view from the second viewpoint 403 is a second projection matrix. In addition, a projection matrix for drawing a CG in a view from the third viewpoint 404 is assumed to be a third projection matrix. For example, the first projection matrix is determined based on a field of view corresponding to the first viewpoint 402. The second projection matrix is determined based on a field of view corresponding to the second viewpoint 403. The third projection matrix is determined based on a field of view corresponding to the third viewpoint 404. The first-object drawing unit 110 draws an image of the first object 406 on a rendering target using the third projection matrix as though the second object 405 is not present.

Let us assume that the third viewpoint 404 is a midpoint between the first viewpoint 402 and the second viewpoint 403. Let us also assume that a frustum of rendering for drawing a CG in a view from the first viewpoint 402 and a frustum of rendering for drawing a CG in a view from the second viewpoint 403 are respectively bilaterally symmetrical. In such a case, normally, since the first projection matrix and the second projection matrix are the same, a same projection matrix as the first projection matrix and the second projection matrix is used as the third projection matrix. When the two frustums described above are respectively bilaterally asymmetrical, for example, an average (intermediate) projection matrix of the first projection matrix and the second projection matrix is used as the third projection matrix. When one of the first viewpoint 402 and the second viewpoint 403 is selected as the third viewpoint 404, for example, a projection matrix corresponding to the selected viewpoint is used as the third projection matrix.

In step S3030, the first-object drawing unit 110 detects an overlapping region in which an object (second object 405) is present in the foreground of the first object 406 in a view from the third viewpoint 404. This processing is based on, for example, the first object 406 drawn in step S3020 and the second object 405 generated by the second-object generation unit 109. FIG. 5 is a schematic view for describing a processing example of step S3030. A CG scene 501 corresponds to a view from the third viewpoint 404 (the user 401) and the first object 406 and the second object 405 is arranged in the CG scene 501. The first-object drawing unit 110 generates a first depth image 502 constituted of only the second object 405 by removing the first object 406 from the CG scene 501. It is assumed that the greater a distance from a viewpoint, the larger a pixel value of a depth image. In a similar manner, the first-object drawing unit 110 generates a second depth image 503 constituted of only the first object 406 by removing the second object 405 from the CG scene 501. The first-object drawing unit 110 subtracts the first depth image 502 (each pixel value) from the second depth image 503 (each pixel value) and generates a difference image 504. In addition, the first-object drawing unit 110 detects, as an overlapping region, a positive region 505 in which a pixel value of the difference image 504 (a value obtained by subtracting a pixel value of the first depth image 502 from a pixel value of the second depth image 503) is larger than 0.

In step S3040, the first-object drawing unit 110 determines an a value (a blending ratio) at each position of the image of the first object 406 drawn on a rendering target based on the overlapping region 505 detected in step S3030. The a value is a blending ratio when drawing (attaching) the image of the first object 406 on the surface of a third object 407 and the larger the a value, the lower the transparency in which the image of the first object 406 is drawn on the surface of the third object 407. For example, when the a value is 0, transparency is 100% and the image of the first object 406 is not drawn on the surface of the third object 407. When the a value is 0.5, transparency is 50% and a translucent image of the first object 406 is drawn on the surface of the third object 407. When the a value is 1, transparency is 0% and an opaque image of the first object 406 is drawn on the surface of the third object 407. For example, the first-object drawing unit 110 determines the a value of the overlapping region 505 to be 1 and determines the a value of regions other than the overlapping region 505 to be 0. Accordingly, only an image of a portion corresponding to the overlapping region 505 in the first object 406 can be drawn on the surface of the third object 407.

In step S3050, the third-object generation unit 111 generates (defines) the third object 407 in the foreground of the second object 405 in a view from the third viewpoint 404. For example, the transparent third object 407 is generated based on the second object 405 (geometry and transform; position, orientation, and profile) generated by the second-object generation unit 109. Note that an image of the first object 406 can be drawn on the surface of the second object 405 without generating the third object 407. Let us consider a case where the surface of the second object 405 has a complex profile (for example, irregularities). In this case, when an image of the first object 406 is drawn on the surface of the second object 405, a view of the image of the first object 406 may significantly differ between the first viewpoint 402 or the second viewpoint 403 and the third viewpoint 404. Therefore, preferably, the third object 407 with a surface obtained by simplifying the surface of the second object 405 (for example, a surface without irregularities) is generated.

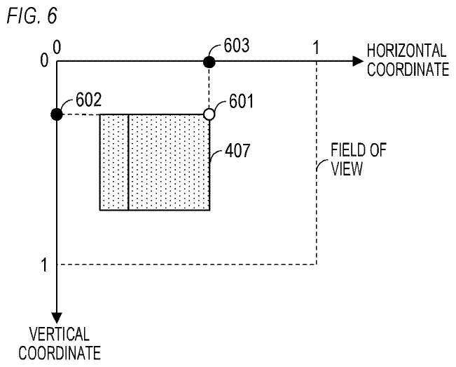

In step S3060, the CG drawing unit 112 calculates a coordinate of each vertex of the third object 407 generated by the third-object generation unit 111. In the present embodiment, an image of the first object 406 is drawn on the surface of the third object 407 so as to project the first object 406 onto the surface of the third object 407. Therefore, the CG drawing unit 112 calculates a two-dimensional coordinate of each vertex of the third object 407 which corresponds to a view from the third viewpoint 404 using the third projection matrix. FIG. 6 is a schematic view for describing a processing example of step S3060. Coordinates 602 and 603 of each vertex 601 of the third object 407 are calculated. The coordinate 602 is a coordinate in a vertical direction and the coordinate 603 is a coordinate in a horizontal direction. The coordinates 602 and 603 are normalized by a size of a field of view.

In step S3070, the CG drawing unit 112 draws an image of the first object 406 on the surface of the third object 407 so as to project the first object 406 onto the surface of the third object 407 based on the coordinates calculated in step S3060. In addition, as a CG (image) including the third object 407 on which the image of the first object 406 has been drawn, the CG drawing unit 112 generates a CG in a view from the first viewpoint 402 and a CG in a view from the second viewpoint 403.

Subsequently, the composition unit 113 generates a composite image corresponding to the first viewpoint 402 by compositing the CG corresponding to the first viewpoint 402 with a real image corresponding to the first viewpoint 402. In addition, the composition unit 113 generates a composite image corresponding to the second viewpoint 403 by compositing a CG corresponding to the second viewpoint 403 with a real image corresponding to the second viewpoint 403. The composite image corresponding to the first viewpoint 402 is presented to the left eye of the user 401 and the composite image corresponding to the second viewpoint 403 is presented to the right eye of the user 401.

As described above, according to the present embodiment, when the third viewpoint is determined and the second object is present in the foreground of the first object in a view from the third viewpoint, an image of the first object is drawn in the foreground of the second object. Subsequently, an image of a view from the first viewpoint corresponding to the left eye and an image of a view from the second viewpoint corresponding to the right eye are generated. Accordingly, suitable display (display which enables binocular vision to be suitably realized) can be readily performed even when visualizing another object which is present in the background of a given object.

For example, when visualizing another object which is present in the background of a given object, a contradiction in anteroposterior relationships of the objects can be suppressed. Accordingly, fusion is to be suitably performed and binocular vision is to be suitably realized. In addition, since complex techniques such as diminished reality are not required, suitable display can be readily performed.

### Modification

Hereinafter, a modification of the embodiment described above will be described. Note that, hereinafter, a description of same points as the embodiment described above (for example, a same configuration and same processing as the embodiment described above) will be omitted and points that differ from the embodiment described above will be described.

The longer a distance (depth) from the third viewpoint, the smaller the difference between a view from the first viewpoint or the second viewpoint and a view from the third viewpoint. Therefore, in the embodiment described above, an example of generating the third object based on a position, an orientation, and a profile of the second object has been described. However, when the second object is a real object, a three-dimensional reconstruction of the second object is required and a large processing load is incurred. In addition, in a case where the difference in views described above is not too much of a problem or a case of an assumption that the second object is not present within a range of a predetermined distance or less from the third viewpoint, the third object may be generated (defined) without generating the second object. In the present modification, an example of generating the third object without generating the second object will be described.

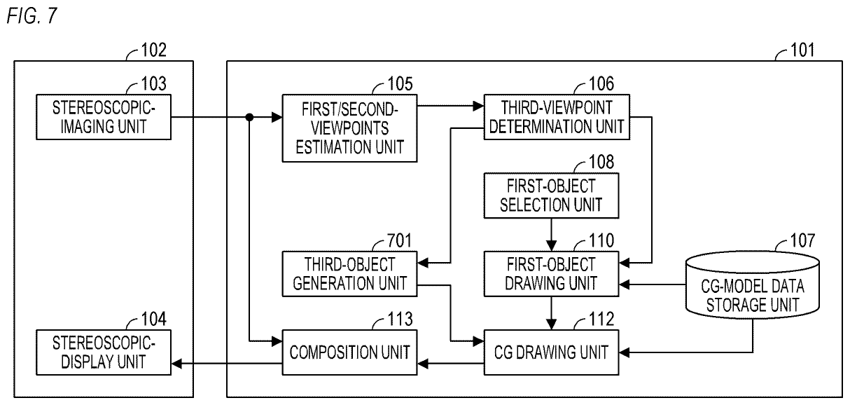

FIG. 7 is a block diagram showing a configuration example of a system according to the present modification. The information-processing apparatus 101 does not include the second-object generation unit 109. A third-object generation unit 701 generates the third object in the foreground of the second object (real object) in a view from the third viewpoint.

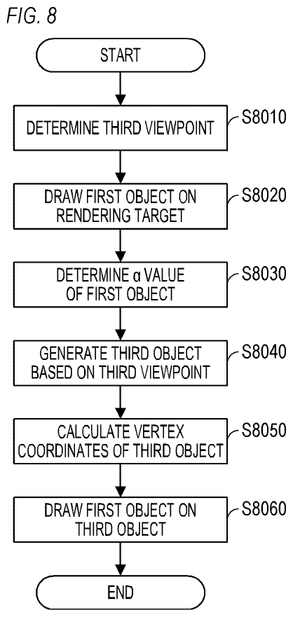

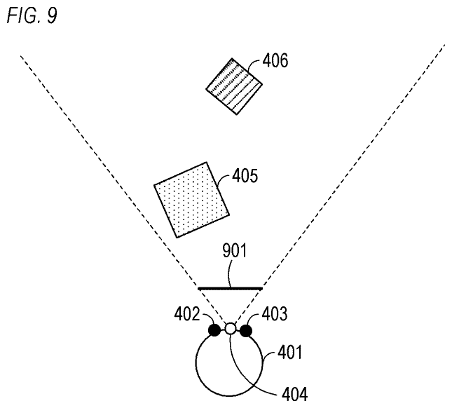

FIG. 8 is a flow chart showing an operation example of the system according to the present modification. FIG. 9 is a schematic plan view showing an example of a positional relationship between each viewpoint and each object.

In step S8010, the third-viewpoint determination unit 106 determines the third viewpoint 404 in a similar manner to step S3010 in FIG. 3. In step S8020, the first-object drawing unit 110 draws an image of the first object 406 on a rendering target in a similar manner to step S3020. In step S8030, the first-object drawing unit 110 determines an a value at each position of the image of the first object 406 drawn on the rendering target in a similar manner to step S3040. For example, the first-object drawing unit 110 determines the a value of an entire region of the first object 406 to be 1 and determines the a value of regions outside of the first object 406 to be 0.

In step S8040, the third-object generation unit 701 generates a third object 901 based on the third viewpoint 404. For example, a surface perpendicular to a line-of-sight direction in accordance with an orientation of the third viewpoint 404 is determined as the third object 901 at a position separated by a predetermined distance from the third viewpoint 404. Note that a method of generating the third object 901 is not limited to the method described above and the third object 901 may be generated so that, for example, a relative position and a relative orientation of the third object 901 with respect to the third viewpoint 404 is a position and an orientation determined in advance.

In step S8050, the CG drawing unit 112 calculates a coordinate of each vertex of the third object 901 generated by the third-object generation unit 701 in a similar manner to step S3060. In step S8060, the CG drawing unit 112 draws an image of the first object 406 on a surface of the third object 901 in a similar manner to step S3070. In addition, the CG drawing unit 112 generates a CG in a view from the first viewpoint 402 and a CG in a view from the second viewpoint 403.

Subsequently, the composition unit 113 generates a composite image corresponding to the first viewpoint 402 and a composite image corresponding to the second viewpoint 403 in a similar manner to the embodiment described above. The composite image corresponding to the first viewpoint 402 is presented to the left eye of the user 401 and the composite image corresponding to the second viewpoint 403 is presented to the right eye of the user 401.

Note that the above-described various types of control may be processing that is carried out by one piece of hardware (e.g., processor or circuit), or otherwise. Processing may be shared among a plurality of pieces of hardware (e.g., a plurality of processors, a plurality of circuits, or a combination of one or more processors and one or more circuits), thereby carrying out the control of the entire device.

Also, the above processor is a processor in the broad sense, and includes general-purpose processors and dedicated processors. Examples of general-purpose processors include a central processing unit (CPU), a micro processing unit (MPU), a digital signal processor (DSP), and so forth. Examples of dedicated processors include a graphics processing unit (GPU), an application-specific integrated circuit (ASIC), a programmable logic device (PLD), and so forth. Examples of PLDs include a field-programmable gate array (FPGA), a complex programmable logic device (CPLD), and so forth.

The embodiment described above (including variation examples) is merely an example. Any configurations obtained by suitably modifying or changing some configurations of the embodiment within the scope of the subject matter of the present invention are also included in the present invention. The present invention also includes other configurations obtained by suitably combining various features of the embodiment.

According to the present invention, suitable display (display which enables binocular vision to be suitably realized) can be readily performed even when visualizing another object which is present in the background of a given object.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-137085, filed on Aug. 25, 2023, which is hereby incorporated by reference herein in its entirety.

What is claimed is:

1. An information-processing apparatus comprising one or more processors and/or circuitry configured to:
perform determination processing of determining a third viewpoint; and
perform generation processing of generating, in a case where a second object is present in foreground of a first object when viewed from the third viewpoint, an image of a view from a first viewpoint corresponding to a left eye and an image of a view from a second viewpoint corresponding to a right eye by drawing an image of the first object in foreground of the second object.

2. The information-processing apparatus according to claim 1, wherein
in the generation processing, an image of the first object is drawn on a surface of the second object.

3. The information-processing apparatus according to claim 1, wherein
the one or more processors and/or circuitry are configured to:
further perform object generation processing of generating a third object in foreground of the second object, and
in the generation processing, an image of the first object is drawn on a surface of the third object.

4. The information-processing apparatus according to claim 3, wherein
in the object generation processing, the third object is generated based on a position, an orientation, and a profile of the second object.

5. The information-processing apparatus according to claim 3, wherein
in the object generation processing, the third object is generated based on the third viewpoint.

6. The information-processing apparatus according to claim 1, wherein
in the determination processing, the third viewpoint is determined based on at least one of the first viewpoint and the second viewpoint.

7. The information-processing apparatus according to claim 1, wherein
in the determination processing, a midpoint between the first viewpoint and the second viewpoint is determined as the third viewpoint.

8. The information-processing apparatus according to claim 1, wherein
in the determination processing, the first viewpoint or the second viewpoint is determined as the third viewpoint.

9. The information-processing apparatus according to claim 1, wherein
the second object is a real object.

10. The information-processing apparatus according to claim 1, wherein
the second object is a virtual object which reproduces a real object by three-dimensional reconstruction.

11. The information-processing apparatus according to claim 1, wherein
the one or more processors and/or circuitry are configured to:
further perform selection processing of selecting an object designated by a user from one or more objects as the first object.

12. The information-processing apparatus according to claim 1, wherein
the one or more processors and/or circuitry are configured to:
further perform selection processing of automatically selecting an object satisfying predetermined conditions from one or more objects as the first object.

13. The information-processing apparatus according to claim 1, wherein
the image of the first object is an image obtained by projecting the first object onto foreground of the second object.

14. A control method of an information-processing apparatus, comprising:
determining a third viewpoint; and
generating, in a case where a second object is present in foreground of a first object when viewed from the third viewpoint, an image of a view from a first viewpoint corresponding to a left eye and an image of a view from a second viewpoint corresponding to a right eye by drawing an image of the first object in foreground of the second object.

15. A non-transitory computer readable medium that stores a program, wherein the program causes a computer to execute a control method of an information-processing apparatus, the control method comprising:
determining a third viewpoint; and
generating, in a case where a second object is present in foreground of a first object when viewed from the third viewpoint, an image of a view from a first viewpoint corresponding to a left eye and an image of a view from a second viewpoint corresponding to a right eye by drawing an image of the first object in foreground of the second object.
